(19) United States
(12) Patent Application Publication
(10) Pub. No.: US 2013/0244064 A1
(43) Pub. Date: Sep. 19, 2013

(54) MODULAR, PORTABLE AND TRANSPORTABLE ENERGY STORAGE SYSTEMS AND APPLICATIONS THEREOF

(71) Applicant: EFFIONG ETUKUDO IBOK, SUNNYVALE, CA (US)

(72) Inventor: EFFIONG ETUKUDO IBOK, SUNNYVALE, CA (US)

(73) Assignee: EFFIONG ETUKUDO IBOK, SUNNYVALE, CA (US)

(21) Appl. No.: 13/421,904

(22) Filed: Mar. 16, 2012

(51) Int. Cl. H01M 16/00; H01G 9/00; H01M 10/04

(52) U.S. Cl. 429/9; 29/623.1; 29/25.03

(57) ABSTRACT

A modular transportable high capacity energy storage unit is disclosed. This feature facilitates discrete power generation whereby end-users can generate electricity from non-fossil fuel sources in the course of their normal daily activities, completely independent of the electricity grid or major generation facilities. The feature also enables electricity to be transported and traded as commodities irrespective of the location of its generation or relevant electricity infrastructure.

### TECHNICAL FIELD

The present invention relates to the generation and storage of energy in general and portable energy storage devices in particular.

### BACKGROUND ART

The storage of energy is a long established art going back to antiquity. In modern era, no portable electronic device operation would be possible without portable energy storage device (batteries) to go with it. However in these storage devices, the electrical energy is stored as chemical compounds, which rely on the electricity generated by the reaction of these reactants to release the electrons and corresponding flow of electricity. The rate of energy release by these components is gated by the chemical reaction itself along with the physical and electrical transport dynamics in the reaction medium. Even in modern advanced energy generation processes such as fuel cells, the output of electrical power is still bound by these two gating dynamics.

In operation, the desirable functioning of these devices depends on the predesigned control of these electrical and physical transport dynamics since in chemical reactions, the one thing less desirable than an inadequate reaction is a run-away, uncontrolled reaction. Consider exploding batteries.

Additionally in more advanced energy generation devices, the drive towards higher energy capability necessitates the engineering of larger surface areas in those devices; for example through the use of carbon nanotubes. This class of devices brings with it the drawback of degradation of the surface areas through fowling. This effect limits not only the capacity of deliverable energy but the operational longevity of the device itself.

In light of the above limitations, it is desirable to have energy storage devices that have the capability of high energy burst, high energy density and high operational longevity. A source of power which is independent of chemical reaction, physical or electronic transport limitations. Capacitors have shown this capability and have been used extensively and have become a critical component of power management in microelectronics. They are also an essential component of transformers and other electrical infrastructures. However, as these components are scaled up, certain limitations common to all capacitors such as charge non-uniformity in the dielectric media emerge. Charge non-uniformities caused by several physical, compositional and potential gradients in the dielectric media.

These limitations are addressed by the present invention.

As non-fossil fuel energy generation expands, the need to provide a storage buffer between the generation source and the electricity grid also expands. Additionally, in alternative energy generation, be it wind, solar, wave etc., and typically involves feeding the said generated energy into the electricity grid. When there is no access to the grid, whatever energy is generated has to be consumed or lost. There is therefore a need for the capability to transport the generated energy to points of use with or without access to the electricity grid.

In the automotive industry, with the growth of electrically powered motor vehicles, there is a need for alternative of electrical power generation. Typically an EV, whatever the manufacturer, operates with a single on-board source of electrical power. Usually this is a battery pack with capacity of about 30 kWh. This capacity ensures a typical driving range of 100 miles before the battery has to be recharged; typically at a charging receptacle connected to the electricity grid.

In any municipality electricity grid-node, there is a limit beyond which simultaneous EV recharging will cause a brown-out due to excessive drain on the electricity grid for that municipality. Clearly, this is an impediment to the any substantial rollout of EV's. There is therefore a need for the decoupling of the energy source from the grid. Additionally, there is also a need for a transportable high capacity energy storage unit which would obviate the necessity for repeated recharging of the EV's energy source.

Additionally, there is a need for discrete energy generation capability to disconnect the energy end-user from both the grid and large energy generation systems. There is also a corresponding need for modular inter-connectible energy storage devices to complement this discrete generation and end-user independence.

### SCOPE OF THE INVENTION

This invention addresses the limitation of singular energy storage devices by integrating multiple modular storage units interfaced with each other such that the electrical energy content of one unit can be throttled into a connecting unit when energy content of said unit is detected to be below a predetermined threshold. Another scope of this invention is the integration of a high energy density storage component (capacitor) with a high power density component (battery) such that the electrical energy content of the power component is replenished from the storage component when the level in the power component drops below a predetermined threshold. In as yet another scope of this invention is the integration of portable modular storage units such that each component can be charged or discharged to a predetermined threshold in the presence of a power gradient across the component aggregates.

### BRIEF SUMMARY OF THE INVENTION

A method of integrating power density intensive components (batteries) and energy density components (capacitors) into single power supply wherein the electrical energy content in the power density intensive component is replenished from the energy density intensive component when the electrical energy content drops below a predetermined level. Additionally, two or more energy density intensive components are integrated so that each component can be charged or discharged to a predetermined level in the presence of a voltage gradient across the matrix. An integrated modular storage scheme is also disclosed wherein stackable modular storage units are connected to portable energy generation units such as solar vanes. Such storage modules being energized passively for subsequent energy utilization. A method of EV power fabrication wherein the power supply unit comprises an integrated battery and storage unit said storage unit being located anywhere in the care displaced from the battery unit. The power to the battery unit is throttled from the storage unit when it drops below a predetermined level. Since the storage unit is standardized, the battery of an EV does not have to be swapped out being integrated with the storage unit. The storage unit can be replaced or swapped out thus increasing the travel range of the car.

### BRIEF DESCRIPTION OF DRAWINGS

For understanding the present invention, reference is made to the following drawings in the “DETAILED DESCRIPTION OF THE INVENTION”.

In the drawings,

FIG. 1 is a schematic drawing of the EV power supply unit comprising a battery unit and a high energy density storage unit linked by a rectifying diode coupling unit.

FIG. 2 is a schematic of the rectifying connection device.

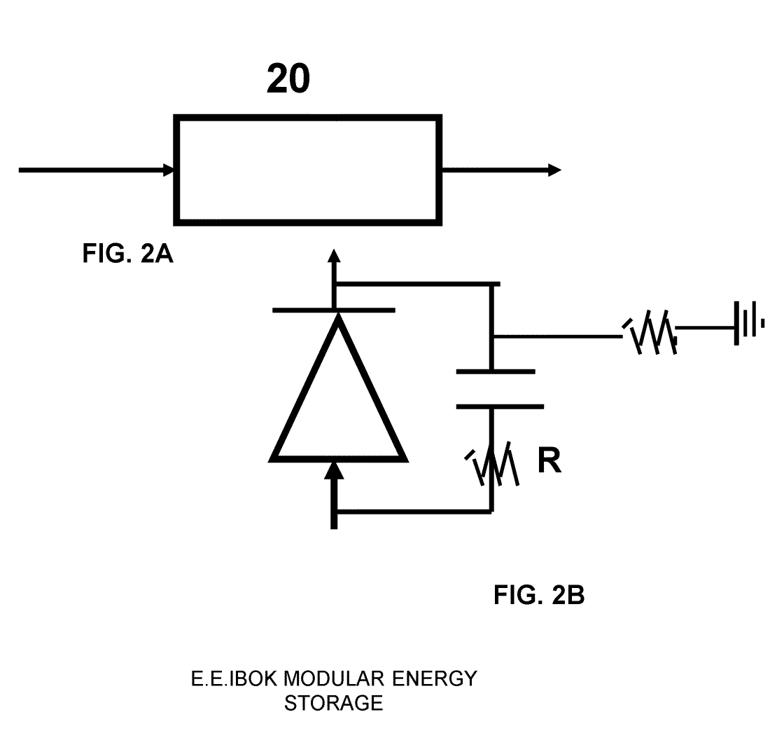

FIG. 3 is a schematic of the stackable modular storage units connected to a portable energy generation unit.

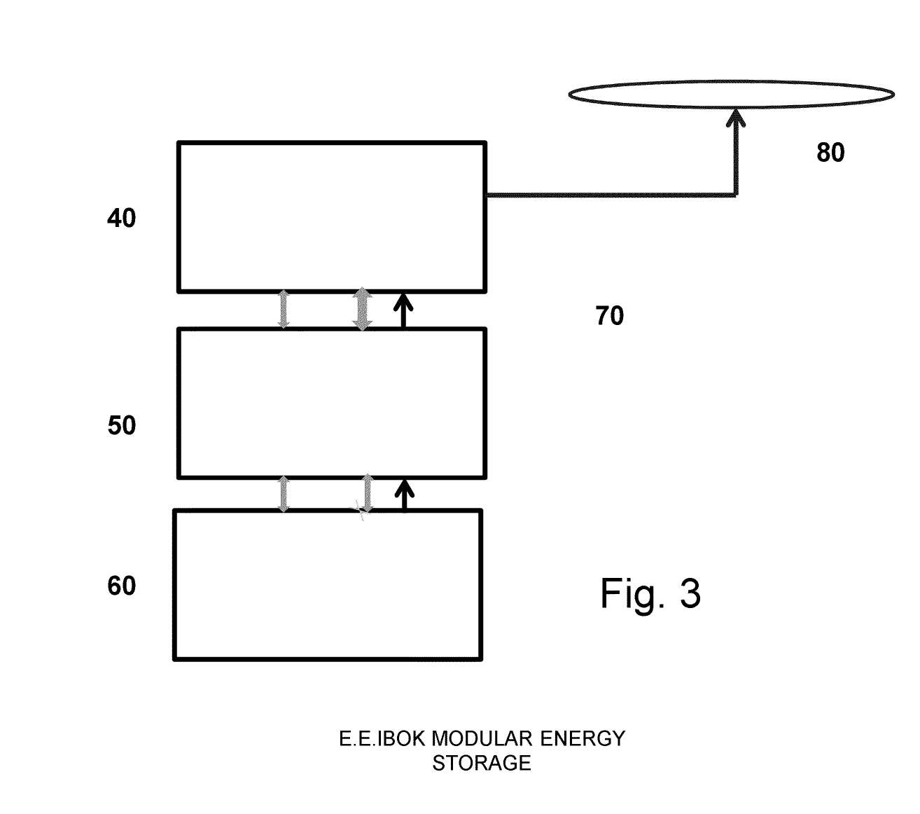

FIG. 4 is a schematic of an integrated battery/storage unit.

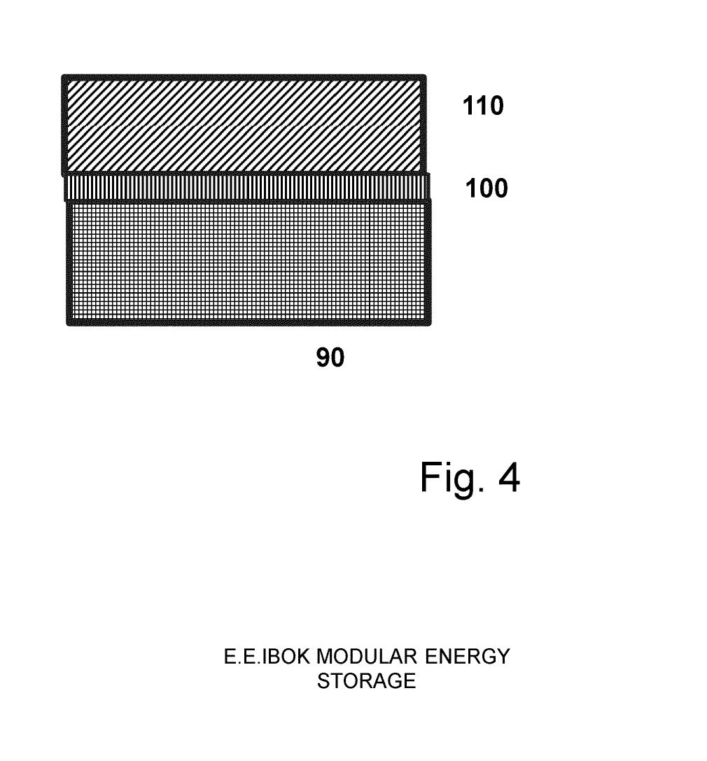

FIG. 5. Is a schematic of a large capacity modular storage system with n units which can be enclosed in a single box of capacity 4 GWh.

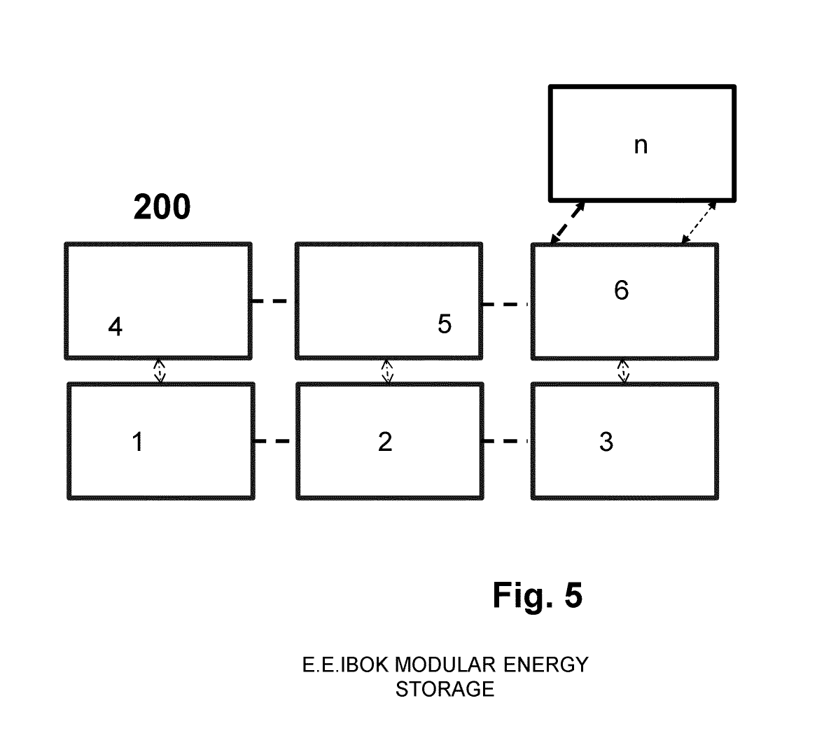

### DETAILED DESCRIPTION OF INVENTION

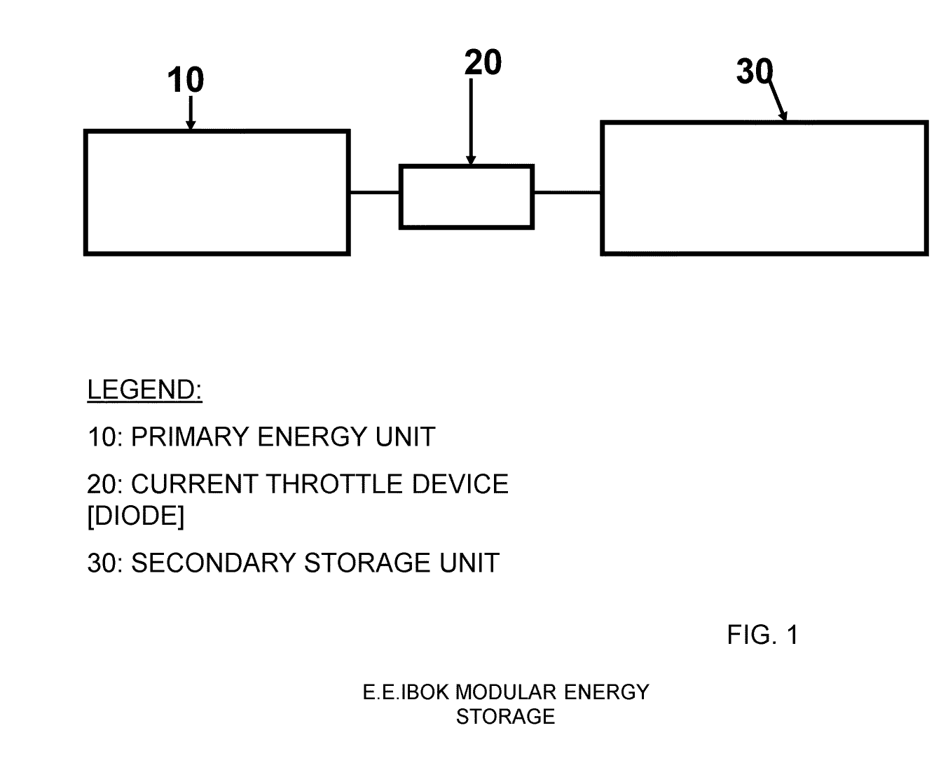

The present invention satisfies these needs. In accordance with this invention, a method of fabricating a modular energy storage device, shown in FIG. 1, is disclosed, comprising:

Providing a first storage unit 10,
Providing a rectifier device 20 connecting the first storage unit thereunto and said rectifying device ensuring the flow of electricity in one direction only and throttling back or blocking the backflow of current
Providing a second storage unit 30 connected to the first by the rectifying device.

Yet another need satisfied by this invention is that of discrete power generation. By this method, solar panels fabricated on flexible fabric-type materials are configured into portable appliances such as umbrellas etc. and power is generated passively in the course of normal daily activity. Said power generated is stored in the modular, stackable portable storage units.

As yet another disclosure of this invention is commoditization of energy. Hereby stored energy is transportable. In this method, energy generated from any source is stored in capacitors of various sizes and capacities. These units can be rented out or purchased. Once exhausted, they storage units are returned for recharging and fully charged units rented out.

By this method, the source of energy generation, storage and utilization can be separated by localities or continents. It does not matter. Discharged units can be returned anywhere for recharging and fully charged units picked up in their place.

Therefore just as fossil fuel can be transported in containers of various shapes and sizes from any part of the globe to any other part of the globe, irrespective of where it was extracted or processed, electricity is transported by this invention to any part of the globe as commodities.

In as yet another component of this invention relates to Electrical Vehicle power sources. In existing art, every manufacturer has its own battery pack and sizes. This invention discloses a standardized energy source which can be used as a stand alone unit or an auxiliary unit as shown in FIG. 1. In this application, the storage capacity ranges up to 500 kWh. As an auxiliary unit, it is connected to primary battery of the vehicle. The advantage of this is one does not have to charge the battery every night as is currently the case or every hundred miles. This invention enables an unlimited travel range since one can acquire as many storage units as needed.

A further disclosure of this invention is the implementation of a distribution system for these portable energy storage units. In this system, energy storage units of various sizes are stocked at various distribution outlets nationwide such as gas stations, grocery stores, transportation terminals and so on. The customer pays only for the electricity used, with a deposit of some amount for the storage container itself. With an account, the customer can replace his storage unit at any location in the country or get credit for any unused electricity in the returned container. This invention facilitates the use of electricity with no concern about location or nature of related infrastructure.

1. A method of fabricating an integrated electrical vehicle power supply system is claimed wherein the system comprises a battery component and a charge storage component, and both components are connected by a diode charge throttling and rectification device, and said rectification devices permitting charge flow only in one direction—from the storage unit to the battery, and said device also enabling the interrogation of the charge level in the battery unit and enabling the initiation of charge transfer from the storage unit to the battery unit when said level drops below a predetermined value, said capability obviating the need for frequent charging of the battery unit and increasing the travel range of the care.

2. The storage units of claim 1 wherein said units are standardized and switchable from car to storage facility and from facility to car in lieu of battery.
